(19) United States
(12) Patent Application Publication
(10) Pub. No.: US 2008/0290171 A1
(43) Pub. Date: Nov. 27, 2008

(54) ILLUMINATION APPARATUS FOR AN IMAGING-BASED BAR CODE READER

(75) Inventor: Igor Vinogradov, New York, NY (US)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: Symbol Technologies, Inc., Holtsville, NY (US)

(21) Appl. No.: 11/751,142

(22) Filed: May 21, 2007

(51) Int. Cl. G06K 7/10

(52) U.S. Cl. 235/462.06

(57) ABSTRACT

An illumination apparatus (40) for an imaging-based bar code reader (10) having a field of view (FV) defined by an imaging system (12) of the bar code reader directed toward a target object (32). The illumination apparatus (40) includes: an illumination source (42); an aperture plate (44) defining a plurality of spaced apart apertures (44a-44f) aligned with the illumination source (42) such that illumination generated by the illumination source (42) passes through each of the plurality of apertures (44a-44f) of the aperture plate (44); and a lens array (46) defining a plurality of substantially contiguous lens elements (46a-46f) aligned with respective apertures (44a-44f) of the aperture plate (44) such that for each aperture (44a-44f) of the aperture plate (44) illumination passing through the aperture (44a-44f) is focused by a respective corresponding lens element (46a-46f).

### FIELD OF THE INVENTION

The present invention relates to an illumination apparatus for an imaging-based bar code reader and, more particularly, to an illumination apparatus for an imaging-based bar code reader including an illumination array of spaced apart illumination sources, an aperture plate defining an array of apertures aligned with respective illumination sources of the illumination array and a lens array defining an array of lens elements aligned with respective apertures of the aperture plate to focus illumination in a well-defined pattern having sharp peripheral edges toward a target bar code.

### BACKGROUND ART

Various electro-optical systems have been developed for reading optical indicia, such as bar codes. A bar code is a coded pattern of graphical indicia comprised of a series of bars and spaces of varying widths, the bars and spaces having differing light reflecting characteristics. Some of the more popular bar code symbologies include: Uniform Product Code (UPC), typically used in retail stores sales; Data Matrix, typically used for labeling small electronic products; Code 39, primarily used in inventory tracking; and Postnet, which is used for encoding zip codes for U.S. mail. Bar codes may be one dimensional (1D), i.e., a single row of graphical indicia such as a UPC bar code or two dimensional (2D), i.e., multiple rows of graphical indicia comprising a single bar code, such as Data Matrix which comprising multiple rows and columns of black and white square modules arranged in a square or rectangular pattern.

Systems that read bar codes (bar code readers) electro-optically transform the graphic indicia into electrical signals, which are decoded into alphanumerical characters that are intended to be descriptive of the article or some characteristic thereof. The characters are then typically represented in digital form and utilized as an input to a data processing system for various end-user applications such as point-of-sale processing, inventory control and the like.

Bar code readers that read and decode bar codes employing imaging systems are typically referred to as imaging-based bar code readers or bar code scanners. Imaging systems include charge coupled device (CCD) arrays, complementary metal oxide semiconductor (CMOS) arrays, or other imaging sensor arrays having a plurality of photosensitive elements (photosensors) defining image pixels. An illumination apparatus or system comprising light emitting diodes (LEDs) or other light source directs illumination toward a target object, e.g., a target bar code. Light reflected from the target bar code is focused through a system of one or more lens of the imaging system onto the pixel array. Thus, the target bar code within a field of view (FV) of the imaging lens system is focused on the sensor array.

Periodically, the pixels of the sensor array are sequentially read out generating an analog signal representative of a captured image frame. The analog signal is amplified by a gain factor and the amplified analog signal is digitized by an analog-to-digital converter. Decoding circuitry of the imaging system processes the digitized signals representative of the captured image frame and attempts to decode the imaged bar code.

As mentioned above, imaging-based bar code readers typically employ an illumination apparatus or system to flood a target object with illumination from a light source such as a light emitting diode (LED) in the reader. Light from the light source or LED is reflected from the target object. The reflected light is then focused through the imaging lens system onto the sensor array, the target object being within a field of view of the imaging lens system.

The illumination apparatus is designed to direct a pattern of illumination toward a target object such that the illumination pattern approximately matches the field of view (FV) of the imaging system. One problem with prior art illumination systems is that of lack of definition and nonuniformity of the illumination pattern. Generally, in prior art illumination systems, the pattern of illumination generated by the illumination system resembles a “blob” of illumination having an intensity that is greatest in a central area or portion of the illumination pattern, while the outer or fringe areas of the illumination pattern have a reduced illumination intensity. Because of the lack of sharpness and nonuniformity of the illumination pattern, users of a bar code reader may have difficulty “aiming” the bar code reader at a target bar code when the bar code reader is used in a “point and shoot” method of operation.

To help alleviate this problem, prior art bar code readers typically including an aiming apparatus or system that projects a visible aiming illumination, pattern (such as a visible “crosshair” pattern) that is generally congruent with a center of the imaging system field of view FV to facilitate properly aiming the bar code reader at a target bar code. While a visible aiming pattern is of help, such an aiming apparatus increases the cost of the imaging system and being an additional assembly increases the size or “footprint” of the imaging system camera assembly, both of which are disadvantageous. Further, a crosshair aiming pattern does not in many instances provide the user with a feel for the size of the field of view FV of the imaging system, that is, it does not mark or indicate the bounds of the field of view. Thus, if because of the position or location of the target bar code, the user is unable to align the crosshairs of the aiming pattern on the target bar code, the user will not know if the target bar code may is within the imaging system field of view FV and, therefore, capable of being successfully read (imaged & decoded).

What is needed is an illumination apparatus or system that generates a visible, well-defined illumination pattern that substantially conforms to the imaging system field of view FV thereby eliminating the need for an aiming pattern system.

### SUMMARY

In one aspect, the present invention features an illumination apparatus or system for an imaging-based bar code reader having a field of view defined by an imaging system of the bar code reader directed toward a target object. The illumination apparatus includes: an illumination array defining a plurality of spaced apart visible illumination sources; an aperture plate spaced from the illumination array in a direction of the field of view and defining a plurality of spaced apart apertures aligned with respective illumination sources of the illumination array such that illumination generated by each illumination source passes through a respective corresponding aperture of the aperture plate; and a lens array spaced from the aperture plate in a direction of the field of view and defining a plurality of substantially contiguous lens elements aligned with respective apertures of the aperture plate such that for each aperture of the aperture plate illumination passing through the aperture is focused by a respective corresponding lens element, lens elements of the lens array combining to generate a visible illumination pattern substantially corresponding to the field of view of the imaging system.

In one exemplary embodiment, the plurality of lens elements of the lens array are configured such that a maximum sharpness of peripheral edges of the illumination pattern occurs at substantially a best in-focus target plane of the imaging system. In one embodiment, the lens array is spaced from the aperture plate and located at a position that substantially corresponds to a focal plane of the plurality of lens elements.

In one exemplary embodiment, the illumination array comprises an array of LEDs generating illumination in the visible range, the aperture plate comprises an array of rectangular apertures, and the lens elements of the lens array have a positive optical power.

In one aspect, the present invention features a bar code reader including an imaging system including a lens and a sensor array for focusing illumination from a target object onto the sensor array, the imaging system defining a field of view directed toward the target object; and an illumination apparatus for directing an illumination pattern toward the target object. The illumination apparatus includes: an illumination array defining a plurality of spaced apart visible illumination sources; an aperture plate spaced from the illumination array in a direction of the field of view and defining a plurality of spaced apart apertures aligned with respective illumination sources of the illumination array such that illumination generated by each illumination source passes through a respective corresponding aperture of the aperture plate; and a lens array spaced from the aperture plate in a direction of the field of view and defining a plurality of substantially contiguous lens elements aligned with respective apertures of the aperture plate such that for each aperture of the aperture plate illumination passing through the aperture is focused by a respective corresponding lens element, lens elements of the lens array combining to generate a visible illumination pattern substantially corresponding to the field of view of the imaging system.

In one exemplary embodiment, the plurality of lens elements of the lens array are configured such that a maximum sharpness of peripheral edges of the illumination pattern occurs at substantially a best in-focus target plane of the imaging system. In one embodiment, the lens array is spaced from the aperture plate and located at a position that substantially corresponds to a focal plane of the plurality of lens elements.

In one exemplary embodiment, the illumination array comprises an array of LEDs generating illumination in the visible range, the aperture plate comprises an array of rectangular apertures, and the lens elements of the lens array have a positive optical power.

In one aspect, the present invention features an illumination apparatus for an imaging-based bar code reader having a field of view defined by an imaging system of the bar code reader directed toward a target object. The illumination apparatus includes: an illumination source providing a source of visible illumination; an aperture plate spaced from the illumination source in a direction of the field of view and defining a plurality of spaced apart apertures aligned with the illumination source such that illumination passes through a respective corresponding aperture of the aperture plate; and a lens array spaced from the aperture plate in a direction of the field of view and defining a plurality of substantially contiguous lens elements aligned with respective apertures of the aperture plate such that for each aperture of the aperture plate illumination passing through the aperture is focused by a respective corresponding lens element, lens elements of the lens array combining to generate an illumination pattern substantially corresponding to the field of view of the imaging system wherein a sharpness of peripheral edges of the illumination pattern is maximum at substantially a best in-focus target plane of the imaging system.

These and other objects, advantages, and features of the exemplary embodiments are described in detail in conjunction with the accompanying drawings.

### BRIEF DESCRIPTION OF THE DRAWINGS

The foregoing and other features and advantages of the present invention will become apparent to one skilled in the art to which the present invention relates upon consideration of the following description of the invention with reference to the accompanying drawings, in which:

FIG. 1 is a schematic side elevation view of an exemplary embodiment of an imaging-based bar code reader of the present invention;

FIG. 2 is a schematic front elevation view of the bar code reader of FIG. 1;

FIG. 3 is a schematic top plan view of the bar code reader of FIG. 1;

FIG. 4 is a schematic view partly in section and partly in side elevation of a camera assembly of an imaging assembly of the bar code reader of FIG. 1;

FIG. 5 is a schematic block diagram of the bar code reader of FIG. 1;

FIG. 6 is a schematic perspective view of an illumination apparatus of the present invention;

FIG. 7 is a schematic vertical sectional view through a lens array of the illumination apparatus of FIG. 6 as seen from a plane indicated by the cut line 7-7 in FIG. 6;

FIG. 8 is a schematic horizontal sectional view through the lens array as seen from a plane indicated by the cut line 8-8 in FIG. 6;

FIG. 9 is a schematic representation of illumination intensity of the illumination pattern generated by the illumination apparatus of FIG. 6 at a distance that generally corresponds to a best in-focus target plane of an imaging lens assembly of the bar code reader; and

FIG. 10 is a schematic representation of illumination intensity of the illumination pattern generated by the illumination apparatus of FIG. 6 at a distance that is substantially beyond to the best in-focus target plane of the imaging lens assembly of the bar code reader.

### DETAILED DESCRIPTION

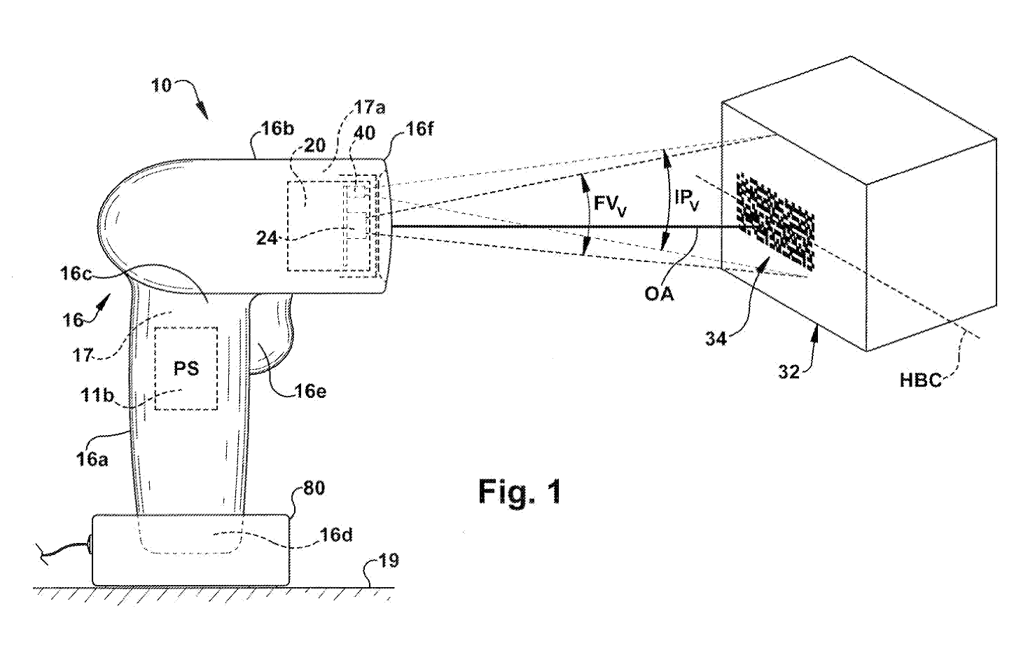

An exemplary embodiment of an imaging-based bar code reader of the present invention is shown schematically at 10 in FIGS. 1-5. The bar code reader 10 includes an imaging system 12 and a decoding system 14 mounted in a housing 16. The reader 10 is capable of reading, that is, imaging and decoding bar codes. The imaging system 12 is adapted to capture image frames of a field of view FV of the imaging system 12 and the decoding system 14 is adapted to decode encoded indicia within a captured image frame. The housing 16 supports circuitry 11 of the reader 10 including the imaging and decoding systems 12, 14 within an interior region 17 of the housing 16.

The imaging system 12 comprises a modular scan engine or imaging camera assembly 20 and associated imaging circuitry 22. The imaging camera assembly 20 includes a housing 24 supporting an imaging lens assembly 26, including one or more imaging lens, which focus illumination from the field of view FV onto a sensor or pixel array 28. The imaging lens assembly 26 includes a one or more imaging lens and an aperture stop. One suitable imaging lens assembly is disclosed in U.S. Ser. No. 11/731,835, filed Mar. 30, 2007 and entitled “Compact Imaging Lens Assembly for an Imaging-Based Bar Code Reader.” The '835 application is assigned to the assignee of the present invention and is incorporated herein in its entirety by reference.

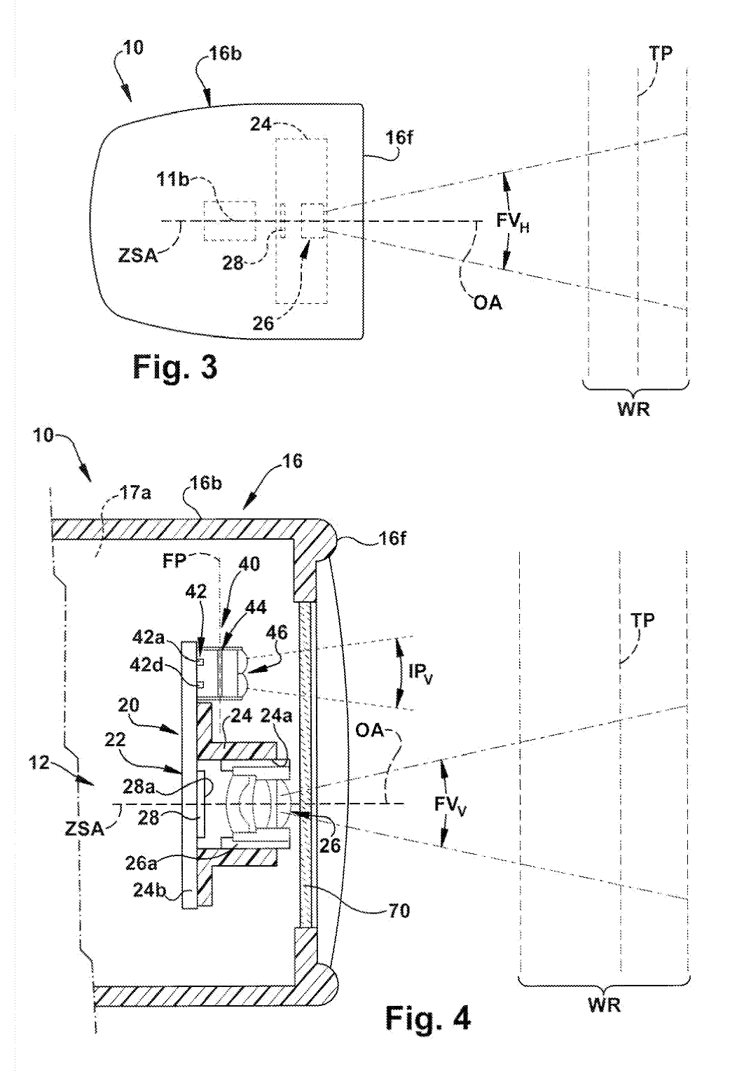

The sensor array 28 is enabled during an exposure period to capture an image of a target object 32 having a target bar code 34 within a field of view FV of the imaging system 12. The field of view FV of the imaging system 12 is a function of both the configuration of the sensor array 28 and the optical characteristics of the imaging lens assembly 26 and the distance and orientation between the array 28 and the imaging lens assembly 26. The imaging lens assembly 26 defines a best or most in-focus target plane TP (shown schematically FIGS. 3 and 4). The target plane TP is a plane orthogonal to an optical axis OA of the imaging lens assembly 26 and within the field of view FV of the imaging system 12 a distance in front of the reader 10 at which a target object 32 would be focused with the greatest clarity or resolution onto the sensor array 28. It should be appreciated that although the best in-focus target plane TP is fixed (for an fixed position imaging system), the depth of field or working range WR (shown schematically in FIGS. 3 and 4) for a given lens assembly allows decodable images to be captured from the target bar code 34 in a distance range about or surrounding the target plane TP. As is seen in FIGS. 3 and 4 the working range WR envelopes the target plane TP. Of course, the working range WR is, among other things, dependent on the size and density of the target bar code 34.

In one exemplary embodiment, the imaging system 12 is a two dimensional (2D) imaging system and the sensor array 28 is a 2D sensor array. It should be understood, however, that the present invention is equally applicable to a linear or one dimensional imaging system having a 1D sensor array.

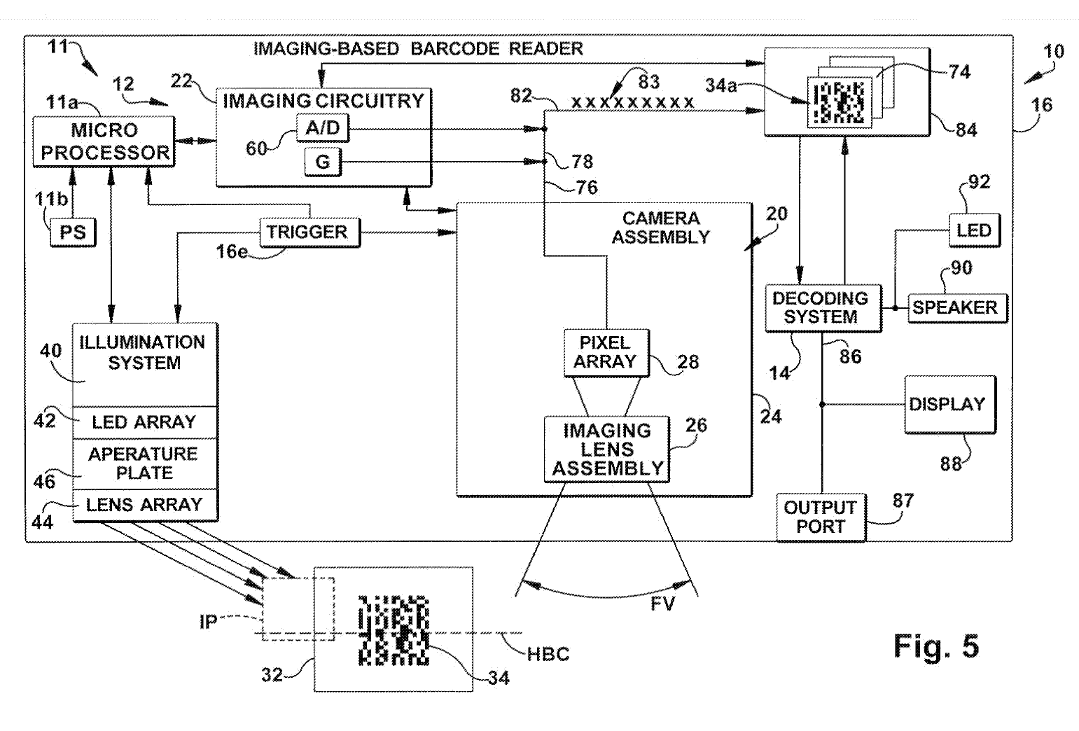

The imaging system 12 field of view FV (shown schematically in FIG. 5) includes both a horizontal and a vertical field of view, the horizontal field of view being shown schematically as FVH in FIG. 3 and the vertical field of view being shown schematically as FVV in FIGS. 1 and 4. The sensor array 28 is primarily adapted to image 1D and 2D bar codes, for example, a Data Matrix bar code as shown in FIG. 1 which extends along a horizontal axis HBC and includes multiple rows of indicia comprising a multi-row, multi-column array of dark bars and white spaces. However, one of skill in the art would recognize that the present invention is also applicable to image postal codes, signatures, etc.

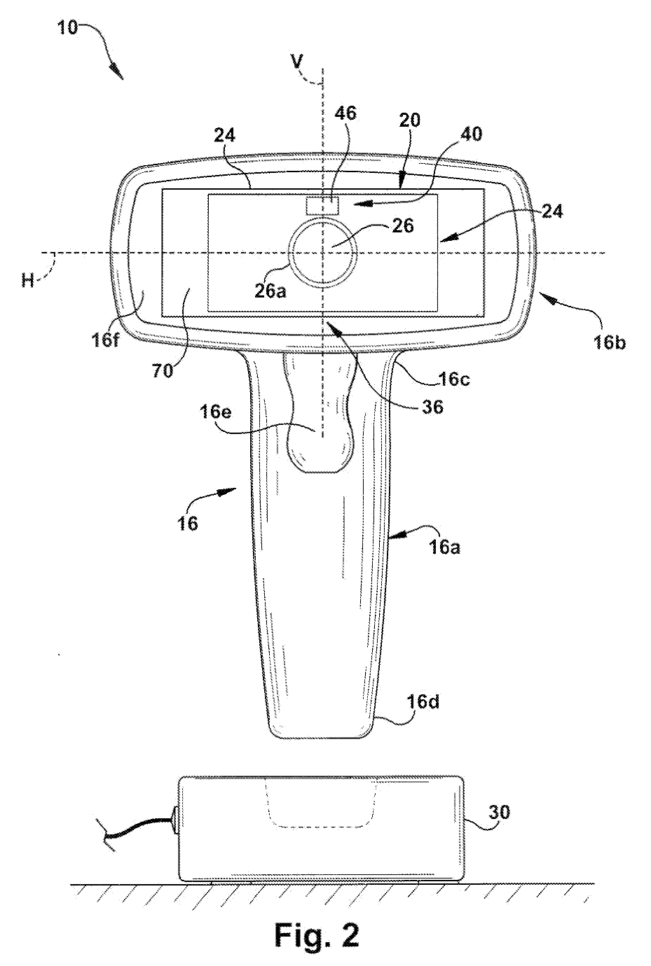

The housing 16 includes a gripping portion 16a adapted to be grasped by an operator's hand and a forward or scanning head portion 16b extending from an upper part 16c of the gripping portion 16a. A lower part 16d of the gripping portion 16a is adapted to be received in a docking station 30 positioned on a substrate 19 such as a table or sales counter. The scanning head 16b supports the imaging system 12 within an interior region 17a (FIG. 4) of the scanning head 16b. As can best be seen in FIG. 2, looking from the front of the housing 16, the scanning head 16b is generally rectangular in shape and defines a horizontal axis H and a vertical axis V. The vertical axis V being aligned with a general extent of the gripping portion 16a.

Advantageously, the reader 10 of the present invention is adapted to be used in both a hand-held mode and a fixed position mode. In the fixed position mode, the housing 16 is received in the docking station 30 and a target object 32 having a target bar code 34 (FIG. 1) is brought within the field of view FV of the reader's imaging system 12 in order to have the reader 10 read the target bar code 34. The imaging system 12 is typically always on or operational in the fixed position mode to image and decode any target bar code presented to the reader 10 within the field of view FV. The docking station 30 is plugged into an AC power source and provides regulated DC power to circuitry 11 of the reader 10. Thus, when the reader 10 is in the docking station 30 power is available to keep the imaging system 12 on continuously.

In the hand-held mode, the housing 14 is removed from the docking station 30 so the reader 10 can be carried by an operator or user and positioned such that the target bar code 34 is within the field of view FV of the imaging system 12. In the hand-held mode, imaging and decoding of the target bar code 34 is instituted by the operator depressing a trigger 16e extending through an opening near the upper part 16c of the gripping portion 16a.

The imaging system 12 is part of the bar code reader circuitry 11 which operates under the control of a microprocessor 11a (FIG. 5). When removed from the docking station 30, power is supplied to the imaging and decoding systems 12, 14 by a power supply 11b. The imaging and decoding systems 12, 14 of the present invention may be embodied in hardware, software, electrical circuitry, firmware embedded within the microprocessor 11a or the modular camera assembly 20, on flash read only memory (ROM), on an application specific integrated circuit (ASIC), or any combination thereof.

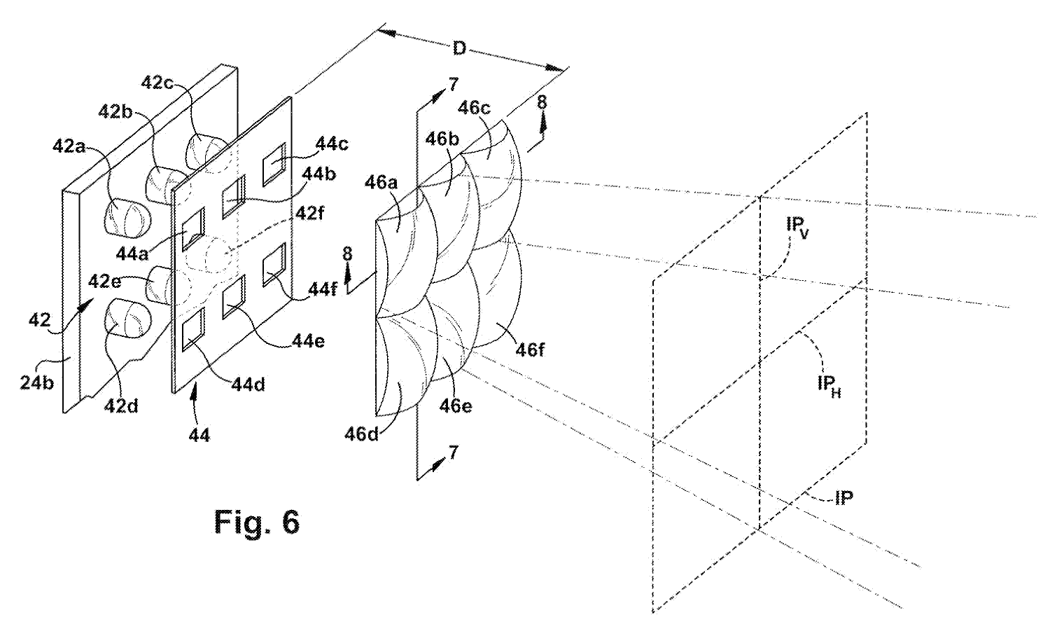

The bar code reader 10 of the present invention includes an illumination apparatus or system 40, described more fully below, to illuminate the target bar code 34 with visible illumination. Advantageously, as can be seen in FIG. 8, when viewed at a distance from the reader 10 that substantially corresponds to the best in-focus target plane TP of the imaging lens assembly 26, a visible illumination pattern IP generated by the illumination apparatus 40 is of maximum sharpness, that is, peripheral edges PE (FIG. 9) of the illumination pattern IP are of maximum sharpness and definition. Additionally, the imaging pattern IP at the best in-focus target plane TP substantially corresponds to the field of view FV of the imaging system 12. That is, at the best in-focus target plane TP, a horizontal extent (labeled IPH in FIG. 6) of the illumination pattern IP substantially corresponds to a horizontal extent of the horizontal field of view FVH and a vertical extent (labeled IPV in FIG. 6) of the illumination pattern IP substantially corresponds to a vertical extent of the vertical field of view FVV. Because of the sharpness of the illumination pattern IP and its correspondence to the imaging system field of view FV, the illumination pattern IP obviates the need for a separate aiming system for the reader 10 as the user of the reader can utilize the illumination pattern IP for aiming purposes and to judge the extent of the field of view FV of the imaging system 12.

The camera housing 24 is supported, within the scanning head interior region 17a in proximity to a transparent window 70 (FIG. 4) defining a portion of a front wall 16f of the scanning bead 16b. The window 70 is oriented such that its horizontal axis is substantially parallel to the scanning head horizontal axis H. The vertical axis of the window 70 maybe tilted slightly to avoid a virtual image of the illumination assembly 40 from being within the field of view FV of the imaging system 12 or may be substantially parallel to the scanning head vertical axis V (as shown in FIG. 4) if having the virtual image does not degrade imaging system performance. Reflected light from the target bar code 34 passes through the transparent window 70, is received by the imaging lens assembly 26 and focused onto the imaging system sensor array 28. In one embodiment, the illumination apparatus 40 may be positioned behind the window 70, thus, illumination from the illumination apparatus 40 also passes through the window 70.

The imaging circuitry 22 may be disposed within, partially within, or external to the camera assembly housing 24. The imaging lens assembly 26 is supported by a lens holder 26a. The camera housing 24 defines a front opening 24a that supports and seals against the lens holder 26a so that the only light incident upon the sensor array 28 is illumination passing through the imaging lens assembly 26.

In one preferred embodiment, the lens holder 26a is fixed with respect to the camera housing 24 in a fixed focus camera assembly. The lens holder 26a is typically made of metal. A back end of the housing 24 may be comprised of a printed circuit board 24b, which forms part of the imaging circuitry 22 and extends vertically to also support an illumination source 42, specifically, in one embodiment, an array of surface mounted LEDs 42a, 42b, 42c, 42d, 42e, 42f of the illumination apparatus 40 (best seen in FIG. 4).

The imaging system 12 includes the linear sensor array 28 of the imaging camera assembly 20. The sensor array 28 comprises a charged coupled device (CCD), a complementary metal oxide semiconductor (CMOS), or other imaging pixel array, operating under the control of the imaging circuitry 22. In one exemplary embodiment, the sensor array 28 comprises a two dimensional (2D) mega pixel CMOS array with a typical size of the pixel array being on the order of 1280×1024 pixels. Each pixel is comprised of a photosensitive element or photosensor that receives light and stores a charge proportional to the intensity of the light received and then is periodically discharged to generate an electrical signal whose magnitude is representative of the charge on the photosensitive element during an exposure period.

The illumination-receiving pixels of the pixel array define a sensor array surface 28a (best seen in FIG. 4). The pixel array 28 is secured to the printed circuit board 24b, in parallel direction for stability. The sensor array surface 28a is substantially perpendicular to the optical axis OA of the imaging lens assembly 26, that is, a z axis (labeled ZSA in FIG. 4) that is perpendicular to the sensor array surface 28a would be substantially parallel to the optical axis OA of the imaging lens assembly 26. The pixels of the sensor array surface 28a are disposed substantially parallel to the horizontal axis H of the scanning head 16b.

As is best seen in FIG. 4, the imaging lens assembly lens 26 focuses light reflected and scattered from the target bar code 34 onto the sensor array surface 28a of the pixel/photosensor array 28. Thus, the imaging lens assembly 26 focuses an image of the target bar code 34 (assuming it is within the field of view FV) onto the array of pixels comprising the pixel array 28. When actuated to read the target bar code 34, the imaging system 12 captures a series of image frames 74 (FIG. 5) which are stored in a memory 84. Each image frame 74 includes an image 34a of the target bar code 34 (shown schematically in FIG. 5). The decoding system 14 decodes a digitized version of the image bar code 34a.

Electrical signals are generated by reading out of some or all of the pixels of the pixel array 28 after an exposure period. After the exposure time has elapsed, some or all of the pixels of pixel array 28 are successively read out thereby generating an analog signal 76 (FIG. 4). In some sensors, particularly CMOS sensors, all pixels of the pixel array 28 are not exposed at the same time, thus, reading out of some pixels may coincide in time with an exposure period for some other pixels.

The analog image signal 76 represents a sequence of photosensor voltage values, the magnitude of each value representing an intensity of the reflected light received by a photosensor/pixel during an exposure period. The analog signal 76 is amplified by a gain factor, generating an amplified analog signal 78. The imaging circuitry 22 further includes an analog-to-digital (A/D) converter 80. The amplified analog signal 78 is digitized by the A/D converter 80 generating a digitized signal 82. The digitized signal 82 comprises a sequence of digital gray scale values 83 typically ranging from 0-255 (for an eight bit processor, i.e., 2⁸=256), where a 0 gray scale value would represent an absence of any reflected light received by a pixel during an exposure or integration period (characterized as low pixel brightness) and a 255 gray scale value would represent a very high intensity of reflected light received by a pixel during an exposure period (characterized as high pixel brightness).

The digitized gray scale values 83 of the digitized signal 82 are stored in the memory 84. The digital values 83 corresponding to a read out of the pixel array 28 constitute the image frame 74, which is representative of the image projected by the focusing lens 26 onto the pixel array 28 during an exposure period. If the field of view FV of the imaging lens assembly 26 includes the target bar code 34, then a digital gray scale value image 34a of the target bar code 34 would be present in the image frame 74.

The decoding circuitry 14 then operates on the digitized gray scale values 83 of the image frame 74 and attempts to decode any decodable image within the image frame, e.g., the imaged target bar code 34a. If the decoding is successful, decoded data 86, representative of the data/information coded in the bar code 34 is then output via a data output port 87 and/or displayed to a user of the reader 10 via a display 88. Upon achieving a good “read” of the bar code 34, that is, the imaged bar code 34a was successfully imaged and decoded, a speaker 90 and/or an indicator LED 92 is activated by the bar code reader circuitry 13 to indicate to the user that the target bar code 34 has successfully read, that is, the target bar code 34 has been successfully imaged and the imaged bar code 34a has been successfully decoded. If decoding is unsuccessful, a successive image frame 74 is selected and the decoding process is repeated until a successful decode is achieved.

### Illumination Apparatus 40

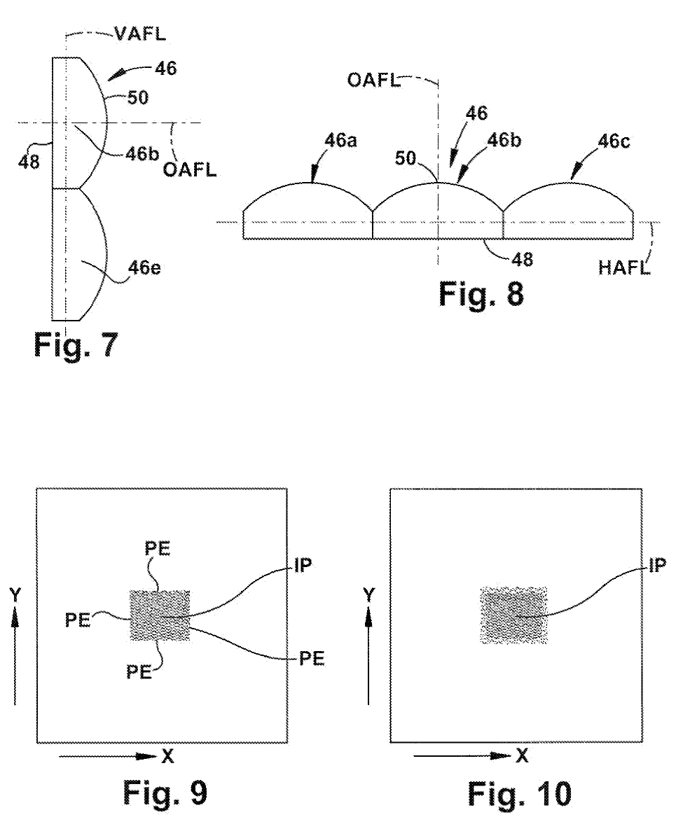

As can be seen in FIGS. 6 and 7, the illumination apparatus or system 40 of the present invention includes the illumination source 42, generating illumination in the visible spectrum so that the generated illumination pattern is visible to the operator or user of the reader 10, an aperture plate 44, and a focusing lens array 46, the aperture plate being intermediate the light or illumination source 42 and the lens array 46. In one exemplary embodiment, the illumination source 42 is an array comprising six spaced apart illumination sources 42a-42f in a two row by three column array (2×3 array), however, it should be understood that depending upon the characteristics of the target bar code 34 to be read, size, density of the bar code elements, surface characteristics of the bar code, etc., the environmental conditions the reader 10 is being used in, such as ambient light conditions, dustiness, etc., the illumination intensity characteristics of the illumination sources, the size of the camera module 20, etc., the illumination apparatus 40 may utilize an array size other than a 2×3 array.

In the exemplary embodiment shown in FIG. 6, the illumination sources 42a-42f are surface mount LEDs which are mounted to the PC board 24b of the camera module 20. Alternately, the illumination source 42 does not have to be an array of surface mount LEDs 42a-42f, the illumination source, for example, may be a single source of visible illumination such as a cold cathode lamp (CFL) or other suitable source of visible illumination known to those of skill in the art. In such an embodiment, the illumination source 42 would be positioned with respect to the aperture plate 44 such that visible illumination is projected onto the plate 44.

The aperture plate 44 is spaced from the illumination source 42 in a direction of the imaging system field of view FV and comprises a 2×3 array of rectangular apertures 44a, 44b, 44c, 44d, 44e, 44f. As best seen in FIG. 6, the position and spacing of the LEDs 42a-42f of the illumination array 42 is matched by the position and spacing of corresponding apertures 44a-44f of the aperture plate 44 such that a portion of the illumination of the LED 42a is directed through the aperture 44a, a portion of the illumination of the LED 42b is directed through the aperture 44b, a portion of the illumination of the LED 42c is directed through the aperture 44c, and so on for all six apertures of the aperture plate 44.

The lens array 46 comprises a 2×3 array of focusing lens elements 46a, 46b, 46c, 46d, 46e, 46f. As best seen, in FIG. 6, the position and spacing of the focusing lens elements 46a-46f of the lens array 46 match the position and spacing of corresponding apertures 44a, 44b, 44c, 44d, 44e, 44f of the aperture plate 44 such that illumination passing through the aperture 44a is received and focused by the focusing lens 46a, illumination passing through the aperture 44b is received and focused by the focusing lens 46b, illumination passing through the aperture 44c is received and focused by the focusing lens 46c and so on. The focused illumination of each lens 46a-46f becomes a component of the illumination pattern IP which is directed toward the target object 32 and corresponds to the imaging system field of view FV.

Each aperture 44a-44f defines a generally rectangular opening 46a is positioned between its corresponding LED 42a-42f and its corresponding focusing lens element 46a-46f of the lens array 46. Each aperture 44a-44f limits the light or illumination from its corresponding LED 42a-42f focused onto the corresponding focusing lens 46a-46f. Each of the focusing lens 46a-46f images or projects the rectangular shape of its corresponding aperture 44a-44f toward the target object 32 thus defining the illumination pattern IP.

The aperture plate 44 is positioned such that each of the apertures 44a-44f is in proximity to a focal plane FP (FIG. 4) of its corresponding focusing lenses 46a-46f. Stated another way, when the aperture plate 44 is positioned at the focal plane FP of the lenses 46a-46f, the spacing between the aperture plate 44 and the lens array 46 is at a distance D (FIG. 6) in the direction of the optical axis (e.g., OAFL in FIGS. 7 and 8) of the lenses 46a-46f such that an image of the apertures 44a-44f projected into the field of view FV would be in focus at the target plane TP. This concept is referred to as positioning the aperture plate 44 at a conjugated distance to the target plane TP. Given the position of the target plane TP, the aperture plate 44 is positioned with respect to lens assembly 46 at a distance D (that is, at the focal plane FP) such that a virtual image of the apertures 44a-44f projected into the field of view FV would be substantially coincident with the target plane TP. The distance D corresponds to a conjugated distance of the best in-focus target plane TP.

The light from the aperture openings 44a-44fa is collected and focused by the respective focusing lenses 46a-46f. A vertical size or dimension of the apertures 44a-44f determine the vertical extent IPV of the illumination pattern IP projected toward the target object 32, while a horizontal size or dimension of the apertures 44a-44f determine the horizontal extent IPH of the illumination pattern IP projected toward the target object 32. The configuration of each of the apertures 44a-44f is substantially the same. The size and the horizontal to vertical size ratio of the apertures 44a-44f in combination with the focal distance of the lens array 46 define the shape and size of the illumination pattern IP at the target plane TP. It should be recognized that depending on the shape or configuration of the illumination pattern IP desired, the shape of the apertures 44a-44f may be other than rectangular, e.g., square or elliptical. Additionally, the edges of the apertures 44a-44f may be other than a straight line to correct for optical distortions caused by the lens array 46.

As noted above, the size, spacing and configuration of the illumination array LEDs 42a-42f, the aperture plate apertures 44a-44f and the lens array focusing lenses 46a-46f are selected and matched such that at the best in-focus target plane TP, the illumination pattern IP has substantially its best definition and sharpness of focus, that is, the peripheral edges PE of the pattern (as shown in FIG. 9) are the sharpest compared to the sharpness of the illumination pattern at any distance from the reader 10 greater or less than the target plane position. Additionally, the horizontal extent IPH of the illumination pattern IP substantially corresponds to a horizontal extent of the horizontal field of view FVH and a vertical extent IPV of the illumination pattern IP substantially corresponds to a vertical extent of the vertical field of view FVV. Stated another way, the plurality of lens elements 46a-46f of the lens array 46 are configured such that a sharpest, best defined illumination pattern IP occurs at substantially a best in-focus target plane TP of the imaging system 12.

As distance is increased beyond the best in-focus target plane TP and beyond the working range WR of the imaging system, because of limitations of the focusing lenses 46a-46f of the lens array 46, the sharpness of the illumination pattern IP progressively degrades and the well defined peripheral edges PE of the pattern IP seen at the best in-focus target plane TP become more rounded in appearance as seen in FIG. 10. Even at distances that are significantly greater that the imaging system working range WR, the extent of the illumination pattern IP still generally corresponds to the extent of the imaging system field of view FV because the horizontal and vertical divergence angles of the illumination pattern generally match the horizontal and vertical divergence angles (FVH, FVV) of the imaging system field of view FV.

The configuration of each of the focusing lenses 46a-46f is substantially the same and the focusing array 46 is preferably fabricated of a single piece of molded plastic optical material such as polycarbonate. Since the lenses 46a-46f of the illumination array 46 are integrated into a single component, this facilitates ease of assembly of the illumination apparatus 40 and since the relative positioning accuracy between each of the lens elements 46a-46f is very high, this provides for very accurate alignment of the illumination beam or pattern emanating from each of the lens elements. Additionally, since the aperture plate 44 is a single component also, this facilitates very accurate alignment between the plate 44 and the lens array 46 during assembly. Typically, the positioning of the LEDs 42a-42f of the lens array 42 is not very accurate and the LED beam direction and divergence are also not accurate. Advantageously, in the illumination assembly 40 of the present invention, the sharpness of the illumination pattern IP is determined only by each of the lens elements 46a-46f and the aperture plate 42, thus, the wide tolerances in LED positioning and beam direction do not negatively impact the sharpness of the illumination pattern IP. Finally, the illumination apparatus 40 of the present invention advantageously allow a designer to select the appropriate number of illumination sources, e.g., six, four, eight, etc., to achieve a desired illumination level of the illumination pattern IP.

The following explanation regarding lens 46b (shown in section in FIGS. 7 and 8) applies equally to all of the lenses 46a-46f. Looking specifically at lens 46b, as best can be seen in the section view of FIG. 7, the lens 46b includes a first optical surface 48 facing the aperture plate 44 and a second or forward facing optical surface 50 facing the window 70 and the target bar code 34.

The first optical surface 48 preferably is a flat optical surface, that is, it is generally parallel with a vertical axis VAFL (FIG. 7) that is orthogonal to an optical axis OAFL of the lens 46b. The second optical surface 50 is preferably a convex optical surface with a positive optical power. The curvature of the second optical surface 50 is substantially constant with respect to the vertical axis VAFL of the lens 46b. The curvature of the second optical surface 50 is also substantially constant with respect to the horizontal axis HAFL (FIG. 8) of the lens 46b. In one preferred embodiment, the curvature of the second optical surface 50 is the same in both the horizontal and vertical axis. It should be recognized of course, that depending on the configuration of the illumination pattern desired, the curvatures of the horizontal and vertical axes of the second optical surface 50 may be different, that is, the surface 50 may be toroidal in shape.

The specific power of the second optical surface 50 will determined by the characteristics of the imaging system 12 including the field of view FV and the position of the best in-focus target plane TP because it is desired that illumination pattern IP generated by the illumination assembly 40 be of maximum sharpness of focus and congruent with the imaging system field of view FV at the target plane TP. Advantageously, each of the lenses 46a-46f of the focusing array 46 focus a substantially congruent pattern of illumination such that the combination of illumination pattern of all six lenses 46a-46f produce a sharp, well-defined illumination pattern IP at the target plane TP.

To insure that the six illumination patterns of the lenses 46a-46f are as congruent as possible, it desirable that the lens array 46 be as small as possible, that is, have as small a “footprint” as possible with respect to the horizontal x and vertical y axes. Obviously, the larger the lenses 46a-46f and the further apart the lenses are from each other, the greater the degree of divergence of the six individual illumination patterns resulting in a lower degree of sharpness of focus of the combined illumination pattern IP. Accordingly, the focusing lenses 46a-46f should be as small and as close together in both the vertical and horizontal directions as possible. Desirably, the lenses 46a-46f of the lens array 46 should be substantially adjacent one to the other or contiguous to minimize the “footprint” of the lens array 46 and minimize divergence of the individual illumination patterns.

By way of example and without limitation, the lenses 46a-46f may have a lens focal number (F#) in the vertical and horizontal plane of approximately 2. This focal number is primarily determined by the optical power of the convex forward facing optical surface 50. The illumination pattern IP produced by the illumination system 40 of the present invention is substantially uniform along both the horizontal and vertical axes.

While the present invention has been described with a degree of particularity, it is the intent that the invention includes all modifications and alterations from the disclosed design falling with the spirit or scope of the appended claims.

I claim:

1. An illumination apparatus for an imaging-based bar code reader having a field of view defined by an imaging system of the bar code reader directed toward a target object, the illumination apparatus comprising:
an illumination array defining a plurality of spaced apart visible illumination sources;
an aperture plate spaced from the illumination array in a direction of the field of view and defining a plurality of spaced apart apertures aligned with respective illumination sources of the illumination array such that illumination generated by each illumination source passes through a respective corresponding aperture of the aperture plate; and
a lens array spaced from the aperture plate in a direction of the field of view and defining a plurality of substantially contiguous lens elements aligned with respective apertures of the aperture plate such that for each aperture of the aperture plate illumination passing through the aperture is focused by a respective corresponding lens element, lens elements of the lens array combining to generate a visible illumination pattern substantially corresponding to the field of view of the imaging system.

2. The illumination apparatus of claim 1 wherein the plurality of lens elements of the lens array are configured such that a maximum sharpness of peripheral edges of the illumination pattern occurs at substantially a best in-focus target plane of the imaging system.

3. The illumination apparatus of claim 1 wherein the lens array is spaced from the aperture plate and located at a position that substantially corresponds to a focal plane of the plurality of lens elements.

4. The illumination apparatus of claim 1 wherein each of the plurality of lens elements of the lens array has a positive optical power.

5. The illumination apparatus of claim 1 wherein each of the plurality of lens elements has a convex optic surface facing the field of view.

6. The illumination apparatus of claim 1 wherein the lens array is comprised of an integral piece of optic material.

7. The illumination apparatus of claim 1 wherein the illumination array comprises an array of LEDs generating illumination in the visible range.

8. The illumination apparatus of claim 1 wherein the aperture plate comprises an array of rectangular apertures.

9. The illumination apparatus of claim 1 wherein the illumination array includes two rows and three columns of illumination sources.

10. An imaging-based bar code reader comprising:
an imaging system including a lens and a sensor array for focusing illumination from a target object onto the photosensor array, the imaging system defining a field of view directed toward the target object; and
an illumination apparatus for directing an illumination pattern toward the target object and including:
an illumination array defining a plurality of spaced apart visible illumination sources;
an aperture plate spaced from the illumination array in a direction of the field of view and defining a plurality of spaced apart apertures aligned with respective illumination sources of the illumination array such that illumination generated by each illumination source passes through a respective corresponding aperture of the aperture plate; and
a lens array spaced from the aperture plate in a direction of the field of view and defining a plurality of substantially contiguous lens elements aligned with respective apertures of the aperture plate such that for each aperture of the aperture plate illumination passing through the aperture is focused by a respective corresponding lens element, lens elements of the lens array combining to generate a visible illumination pattern substantially corresponding to the field of view of the imaging system.

12. The bar code reader of claim 11 wherein the plurality of lens elements of the lens array are configured such that a maximum sharpness of peripheral edges of the illumination pattern occurs at substantially a best in-focus target plane of the imaging system.

13. The bar code reader of claim 11 wherein the lens array is spaced from the aperture plate and located at a position that substantially corresponds to a focal plane of the plurality of lens elements.

14. The bar code reader of claim 11 wherein each of the plurality of lens elements of the lens array has a positive optical power.

15. The bar code reader of claim 11 wherein each of the plurality of lens elements has a convex optic surface facing the field of view.

16. The bar code reader of claim 11 wherein the lens array is comprised of an integral piece of optic material.

17. The bar code reader of claim 11 wherein the illumination array comprises an array of LEDs generating illumination in the visible range.

18. The bar code reader of claim 11 wherein the aperture plate comprises an array of rectangular apertures.

19. The bar code reader of claim 11 wherein the illumination array includes two rows and three columns of illumination sources.

20. A method of imaging a target object, the steps of the method including:
providing an imaging system including a lens and a sensor array for focusing reflected illumination from a target object onto the photosensor array, the imaging system defining a field of view directed toward the target object;
providing an illumination apparatus including an illumination array defining a plurality of spaced apart visible illumination sources; an aperture plate spaced from the illumination array in a direction of the field of view and defining a plurality of spaced apart apertures aligned with respective illumination sources of the illumination array such that illumination generated by each illumination source passes through a respective corresponding aperture of the aperture plate; and a lens array spaced from the aperture plate in a direction of the field of view and defining a plurality of substantially contiguous lens elements aligned with respective apertures of the aperture plate such that for each aperture of the aperture plate illumination passing through the aperture is focused by a respective corresponding lens element, lens elements of the lens array combining to generate a visible illumination pattern substantially corresponding to the field of view of the imaging system; and
energizing the illumination system and the imaging system and imaging the target object.

21. An illumination apparatus for an imaging-based bar code reader including an imaging apparatus defining a field of view directed toward a target object, the illumination apparatus comprising:
illumination array means defining a plurality of spaced apart visible illumination sources;
an aperture plate means spaced from the illumination array in a direction of the field of view and defining a plurality of spaced apart apertures aligned with respective illumination sources of the illumination array such that illumination generated by each illumination source passes through a respective corresponding aperture of the aperture plate; and
a lens array means spaced from the aperture plate in a direction of the field of view, lens elements of the lens array combining to generate a visible illumination pattern substantially corresponding to the field of view of the imaging system.

22. An illumination apparatus for an imaging-based bar code reader having a field of view defined by an imaging system of the bar code reader directed toward a target object, the illumination apparatus comprising:
an illumination source providing a source of illumination;
an aperture plate spaced from the illumination source in a direction of the field of view and defining a plurality of spaced apart apertures aligned with the illumination source such that illumination passes through the plurality of apertures of the aperture plate; and
a lens array spaced from the aperture plate in a direction of the field of view and defining a plurality of substantially contiguous lens elements aligned with respective apertures of the aperture plate such that for each aperture of the aperture plate illumination passing through the aperture is focused by a respective corresponding lens element, lens elements of the lens array combining to generate an illumination pattern substantially corresponding to the field of view of the imaging system wherein a sharpness of peripheral edges of the illumination pattern is a maximum at substantially a best in-focus target plane of the imaging system.

23. The illumination apparatus of claim 22 wherein the illumination source comprises a plurality of spaced apart illumination sources, each illumination source aligned with a respective aperture of the plurality of spaced apart apertures of the aperture plate such that illumination generated by each illumination source passes through a respective corresponding aperture of the aperture plate
